(19) United States
(12) Patent Application Publication
(10) Pub. No.: US 2018/0297762 A1
(43) Pub. Date: Oct. 18, 2018

(54) Storage and display pouch.

(71) Applicant: Keith Delane Amidei, Ann Arbor, MI (US)

(72) Inventor: Keith Delane Amidei, Ann Arbor, MI (US)

(21) Appl. No.: 15/941,820

(22) Filed: Mar. 30, 2018

Related U.S. Application Data
(60) Provisional application No. 62/480,118, filed on Mar. 31, 2017.

(51) Int. Cl. B65D 75/14; B65D 5/38; B65D 5/49; B65D 5/52; B65D 75/52; B65D 77/04; B31B 50/26; B31B 50/73; B31B 50/81

(52) U.S. Cl. CPC B65D 75/14; B65D 5/38; B65D 5/48024; B65D 5/5213; B31B 2120/60; B65D 77/042; B31B 50/26; B31B 50/732; B31B 50/814; B65D 75/525

(57) ABSTRACT

This invention is directed toward a device into which a valuable substance can be stored and displayed. The substance is protected by an insert, which is, in turn, put into a pouch, which opens to allow for its easy insertion and removal from the pouch cavity. The pouch can be closed for protection with a sliding locker. The closed pouch can then be displayed through a package. All components are die-cut and folded for easy assembly.

### CROSS REFERENCE TO RELATED APPLICATIONS

62/480,118

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of storage devices, and more specifically, to a folded pouch used to effectively protect valuable substances, and which has the capability to display the same. This provisional application covers both the pouch itself, the method of making the pouch, and the method of using the pouch to protect the aforementioned valuable substances.

The idea of using folded paper or cardboard die-cut sheets into storage boxes is not new. Paper and cardboard boxes may be the most cost-effective way to give a product protection against the elements. Some packages, particularly ring boxes, can be completely or partially opened to display the contents in an eye-pleasing manner.

However, none of these containers provide an inexpensive, easily made container that can both display and protect a valuable substance.

The current invention provides a solution to this problem with a die-cut thick paper sheet that can be easily folded into a container, where the container can be opened to display the contents. Adding to the protection afforded the valuable substance, one of more folded sheets of various products can be used to wrap and secure the substance, and a sliding locker that secures the insert.

The invention has four basic components. First, a Pouch is created and folded into a container. Second, an Insert is created from folding a second type of material over and around a valuable substance. Third, a Sliding Locker is created and folded, to allow a quick and easy way to put the Insert into the Pouch. Fourth, an element of Packaging is created to externally sealing the Insert in the Pouch, and for allowing, optionally, for the display of the product.

The pouch itself is created from a sheet of material that is die-cut from a template. There are several templates in use currently—a single, a double, and a triple template—and more are contemplated for the future. The material from which the pouch is made can be selected from a number of different sources, including but not limited to paper, cardstock, cardboard, metal, plastic, vinyl and cloth. The size and shape of the pouch can be modified depending on the size and contents of the insert and the valuable substance.

The Insert can be made from any material that can be efficiently folded, and provides the necessary protection for the valuable substance. Depending on the substance to be contained/protected, the insert can be water-resistant or waterproof, UV resistant, provide a sterile or containment-free environment, have the ability to screen out foreign objects and debris, provide various energy spectrum protection such as protection against UV, IR, RFID, etc. Among the contemplated substances from which the insert could be made are paper, parchment, plastic, metal, craft paper, decorative paper, metal leaf paper, thin, transparent plastic, vinyl, etc.

The insert, preferably, is made from a sheet of material that is folded into thirds on both the x- and y-axis, to create nine roughly square sections, which are then folded over each other such that the insert has two overlapping folds on both sides. The size of the insert and the material from which it is made will be dictated by the material to be protected and the size of the pouch.

Examples of the valuable substance can include, but are not limited to, medically-authorized cannabis powders and liquid concentrations, powdered and concentrated medicines, plant seeds, dried herbs, jewels and jewelry, coins, flower petals, gum, small parts, film, stamps, collectibles, candy, RFID chips, film, film negatives, and slides.

The sliding locker is an external item made from, optionally, a wide variety of materials. It is designed to be foldable such that it slides up and down along the folds of the pouch to seal the pouch access flap (to be described in more detail in the detailed description and figures sections).

The external packaging component of the invention can also be made from a wide variety of materials, and can be sized to accommodate single, double, or triple sizes of pouches. The external packaging also has an integral folding display for the pouch, such that a user of the invention can display the contents without having to acquire external devices to help display the products via a mechanism whereby the access flap (to be described more fully in the detailed description and figures sections of this application) can fold “open” to expose the pouch(es) for easy viewing.

### OBJECTS OF THE INVENTION

It is therefore an object of the present invention to provide an economically efficient container into which a user of the invention can store valuable substances.

Additional objects of the invention include:

Providing a pouch that can contain a sliding locker and an insert.

Providing an insert that effective protects the substance.

Providing a sliding locker that can be used to effectively insert and remove the insert from the pouch.

Providing a package that not only holds the sliding locker, insert, and pouch, but also provides an integral display function.

### STATEMENT OF THE INVENTION

Accordingly, one aspect the invention includes a folded pouch, which accommodates a sliding locker, where the sliding locker accommodates an insert, and where the folded pouch additionally comprises display means in the form of a single or multiple pouch that can contain one or more pouches, inserts, and sliding lockers.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a top view of the single pouch version of the invention.

FIG. 2 is a top view of the sliding locker.

FIG. 3 is a top view of the insert.

FIG. 4 is a top view of the single pack display packaging.

FIG. 5 is a top view of the double pack display packaging.

FIG. 6 is a top view of the triple pack display packaging.

FIG. 7 is a series of perspective views of the insert

FIG. 8 is a perspective view of the insert.

FIG. 9 is a series of views of the sliding locker.

FIG. 10 is a series of views of the sliding locker and the pouch.

FIG. 11 is another series of views of the sliding locker and the pouch.

FIG. 12 is a series of views of the single pack version of the display packaging.

FIG. 13 is a series of views of the double pack version of the display packaging.

FIG. 14 is a series of views of the triple pack version of the display packaging.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### REFERENCES CITED

1. [not shown]
2. Access Flap
3. Access Hole
4. Locker Hook Tab
5. Locker Access Flap Tab
6. Insert Opening
7. Locker Access Flap Tab
8. Locker Guide Tab
9. Access Flap Fold
10. Access Flap Bend 1
11. Access Flap Bend 2
12. Top
13. Back
14. Bottom
15. Front
16. [not shown]
17. [not shown]
18. [not shown]
19. [not shown]
20. [not shown]
21. Locker Guide 4
22. Locker Pouch Fold 4
23. Locker Front
24. Locker Pouch Fold 3
25. Locker Guide Fold
26. Locker Pouch Fold 2
27. Locker Guide 3
28. Locker Guide 2
29. Locker Back
30. Locker Pouch Fold 1
31. Locker Hook Fold
32. Locker Guide 1
33. Locker Hook
34. [not shown]
35. [not shown]
36. [not shown]
37. [not shown]
38. [not shown]
39. [not shown]
40. Insert Middle
41. Insert Fold
42. Insert Fold
43. Insert Fold
44. Insert Fold
45. [not shown]
46. [not shown]
47. [not shown]
48. [not shown]
49. [not shown]
50. Closing Tab
51. Front Display Panel
52. Top
53. Back Top
54. Display Fold
55. Back Bottom
56. Side
57. Side Front Tab
58. Display Insert
59. Side Bottom Tab
60. Bottom
61. Closing Insert
62. Front
63. Pouch Separator Fold
64. Front Closure Panel
65. Pouch Separator Gap
66. [not shown]
67. [not shown]
68. [not shown]
69. [not shown]
70. Closing tab
71. Front Display Panel
72. Top
73. Back Top
74. Display Fold
75. Back Bottom
76. Side
77. Side Front Tab
78. Side Bottom Tab
79. Display Insert
80. Bottom
81. Closing Insert
82. Front
83. Front Fold
84. Front Closure Panel
85. Pouch Separator Gap
86. Pouch Separator
87. Pouch Separator Fold
88. Pouch Separator
89. Pouch Separator Gap
90. [not shown]
91. [not shown]
92. [not shown]
93. [not shown]
94. [not shown]
95. [not shown]
96. [not shown]
97. [not shown]
98. [not shown]
99. [not shown]
100. Top
101. Back Top
102. Display Fold
103. Back Bottom
104. Side
105. Side Front Tab
106. Side Bottom Tab
107. Display Insert
108. Bottom
109. Closing Insert
110. Front
111. Front Fold
112. Front Closure Panel
113. Pouch Separator Gap
114. Pouch Separator
115. Pouch Separator Fold
116. Pouch Separator
117. Pouch Separator Gap
118. Pouch Separator
119. Pouch Separator Fold
120. Pouch Separator
121. Pouch Separator Gap
122. Pouch Separator
123. Pouch Separator Gap
124. Separator Tab Insert
125. Internal Side
126. Separator Tab Insert
127. Separator Tab
128. Separator Tab
129. Separator Tab
130. Separator Tab
131. Separator Tab
132. Separator Tab
133. Separator Tab
134. Separator Tab
135. Side Bottom Tab
136. Side Front Tab
137. Internal Side
138. Separator Tab Insert

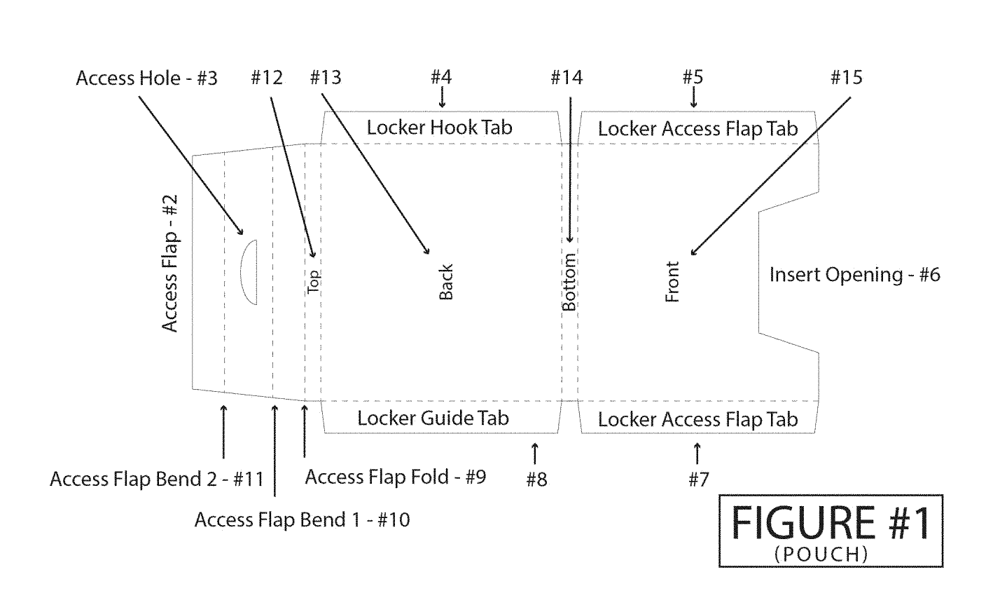

FIG. 1 is a top view of the single pouch version of the invention. The invention is laid out for die-cutting, which not only stamps out the outline of the pouch, but also puts a number of folds into the final product, which allows for easy assembly. The pouch is folded along a bottom 14 and top 12, and then again at a number of access flaps (9, 10, and 11). It is also folded along the sides (4, 5, 7 and 8), such that the front 15 and back 13 form a cavity called an insert opening 6 into which the sliding locker and insert can be inserted. After insertion, the pouch is secured through an access flap 2 which is folded down and inserted into the access opening 6. An access hole 3 is built into the access flap 2.

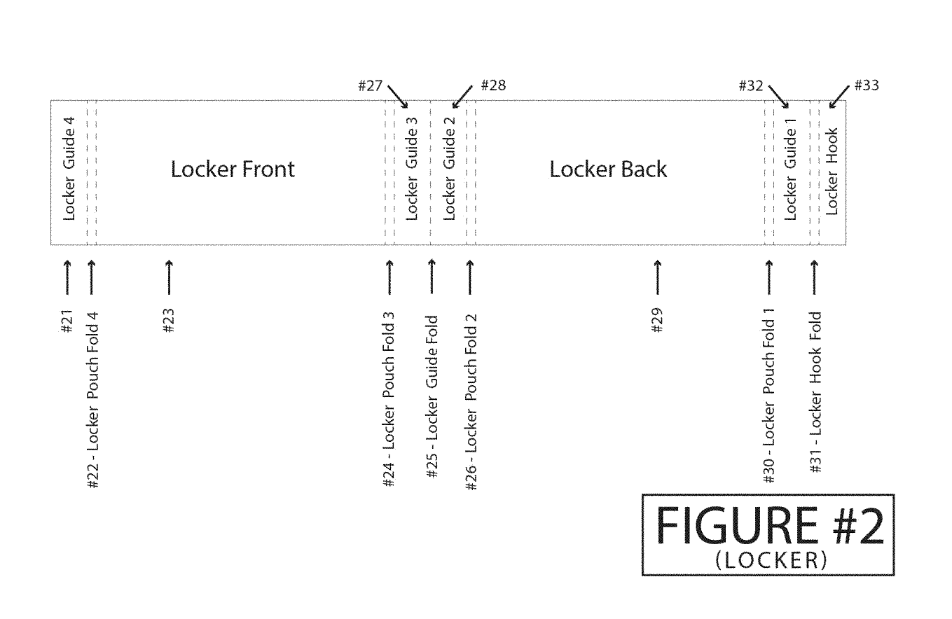

FIG. 2 is a top view of the sliding locker. The sliding locker is also created through a number of vertical and horizontal folds. The sliding locker has a locker front 23 and a locker back 29, which create a cavity between them. A number of locker pocket folds (22, 24, 25, 26, 30 and 31) create the cavity. A number of locker guides (21, 27, 28, 32, and 33) serve to give the sliding locker a cavity into which the insert can be placed. A locker hook 33 allows the sliding locker to be secured around the insert.

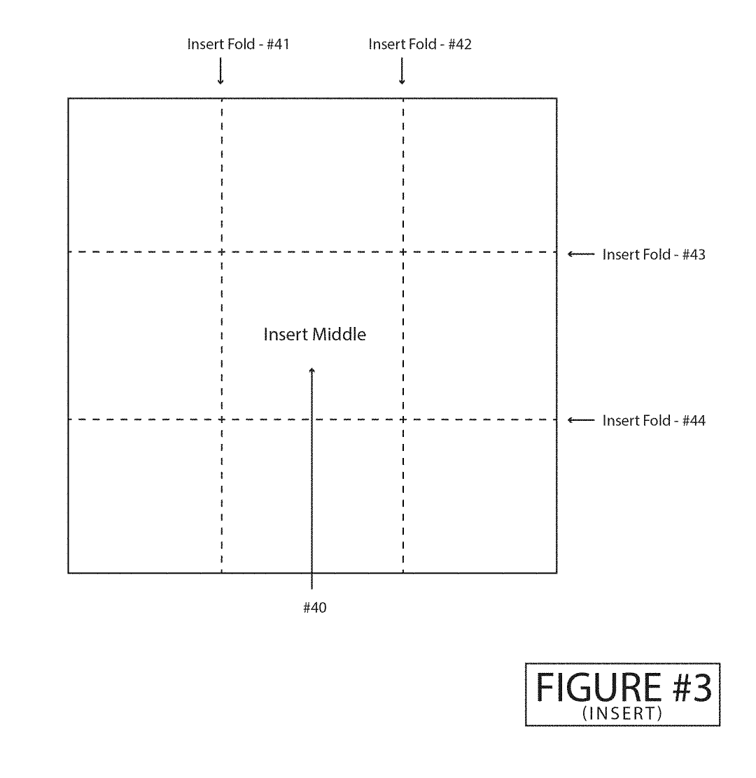

FIG. 3 is a top view of the insert. The insert is created through two folds (41, 42, 43 and 44) along the x and y-axis of the insert. The various sections are folded over each other until the insert middle 40 is the eventual size of the insert. The goal of the insert is to protect the contents and yet still fit into the sliding locker (described in FIG. 2).

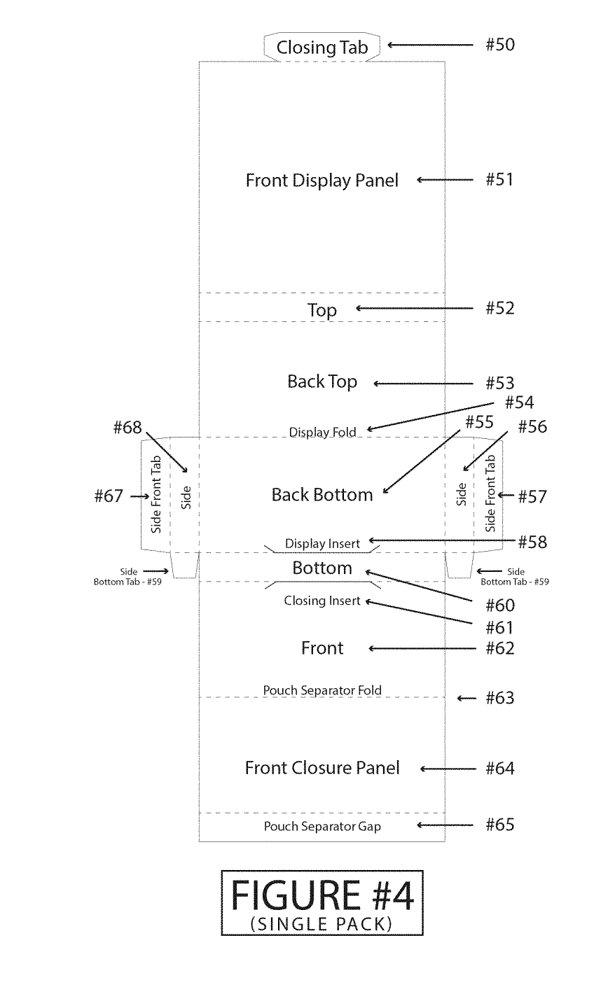

FIG. 4 is a top view of the single pack display packaging. The front display panel 51 is created with a back bottom 55 and a back top 53 through a variety of folds on the sides (56, 57, 66 and 67) and on the main section (54, 63, etc.). After the folding has been accomplished, a closing tab 50 mates with a pouch separator gap 65 to create a three-dimensional display stand.

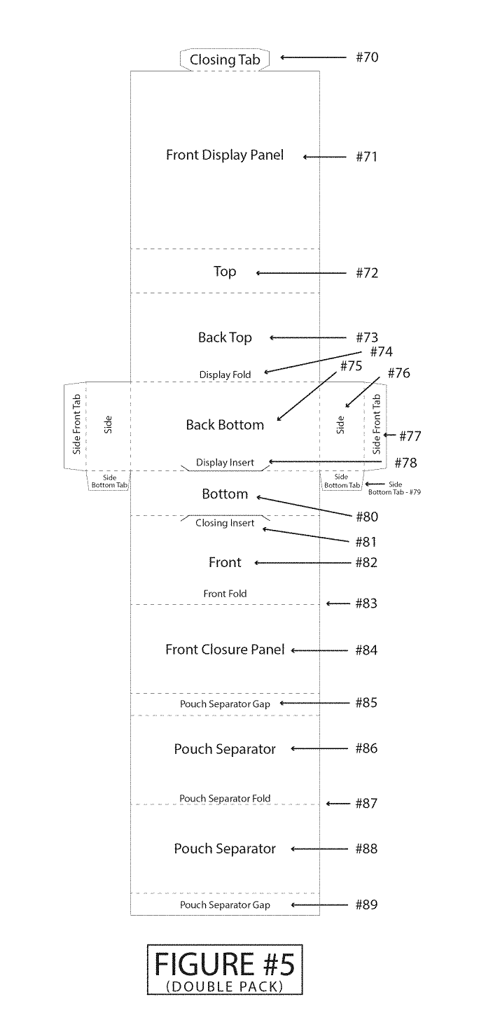

FIG. 5 is a top view of the double pack display packaging. The packaging is designed to fold into a three-dimensional structure that will leave a front display panel 71 exposed and angled such that it will present the product in an eye-catching manner. Various folds separate out a top 72, a back top 73, a back bottom 75 a bottom 80, a front 82 and front closure panel 84. Pouch separator gaps 85 and 89 create a cavity lined by two pouch separators (86 and 88) into which the pouch can be inserted. Sides 75 are folded inward, with side front tabs 77 and side bottom tabs 78 securing the device.

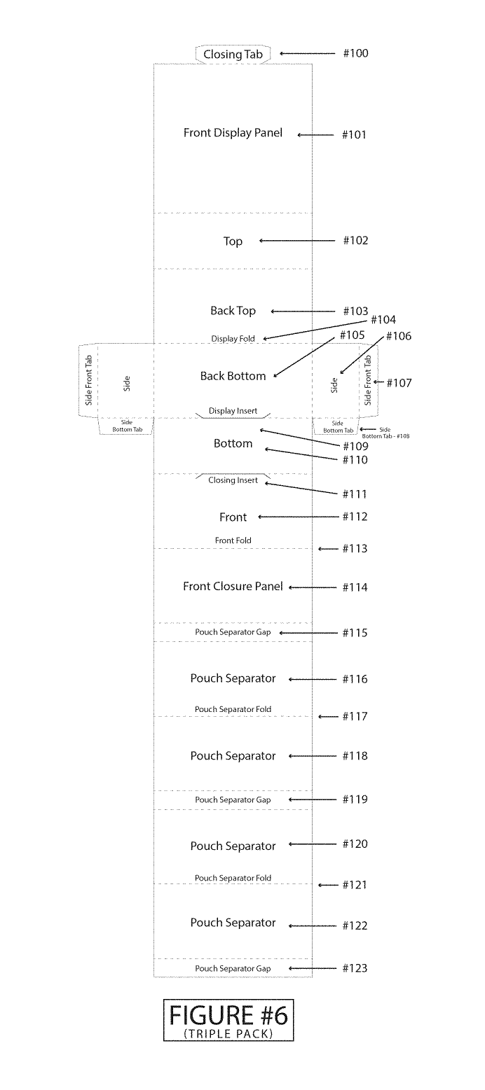

FIG. 6 is a top view of the triple pack display packaging. Again, the goal of the display packaging is to situate a front display panel 101, secured by a closing tab 100, at an appropriate angle, and to display the invention in an eye-pleasing manner. Various folds separate out rectangular sections which are then folded into a three-dimensional display stand that is secured by sides 101, side bottom tabs 108 and side front tabs 107. The front display panel 101 has a top 102, back top 103, back bottom 105, bottom 110, front 112, front closure panel 114 and several pouch separators 116, 118, 120 and 122, all of which have internal cavities created through use of pouch separator gaps 115, 119 and 123, and pouch separator folds 117 and 121.

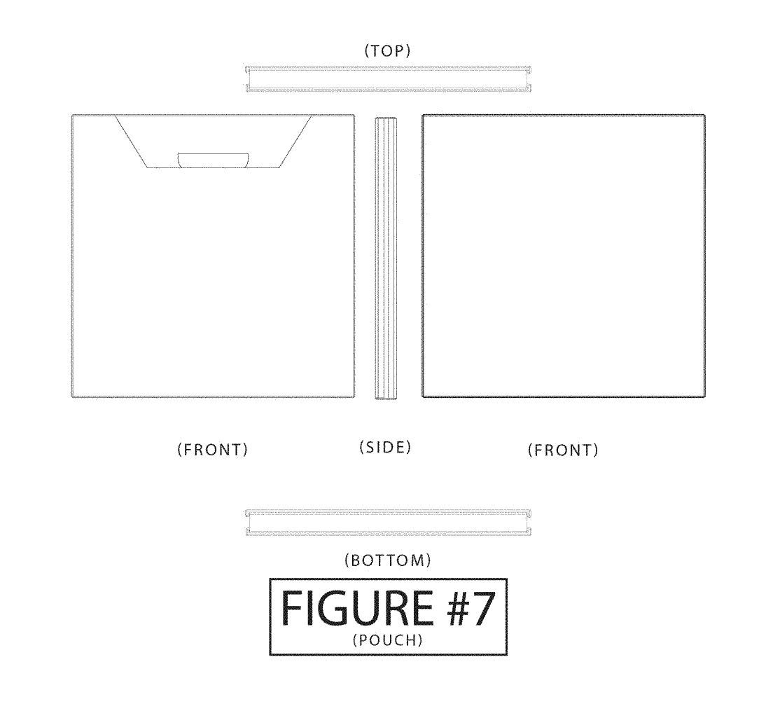

FIG. 7 is a series of different views of the pouch.

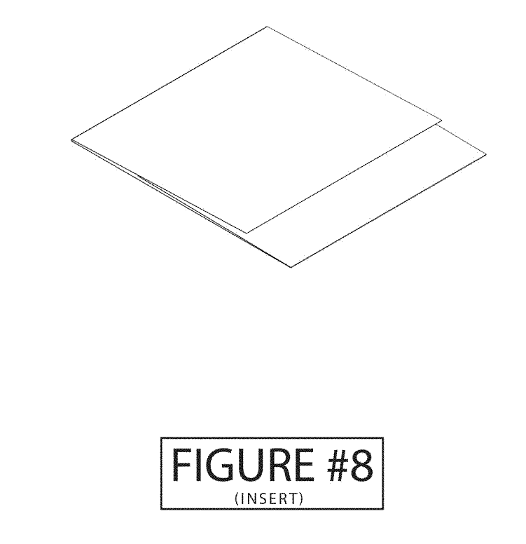

FIG. 8 is a perspective view of the insert.

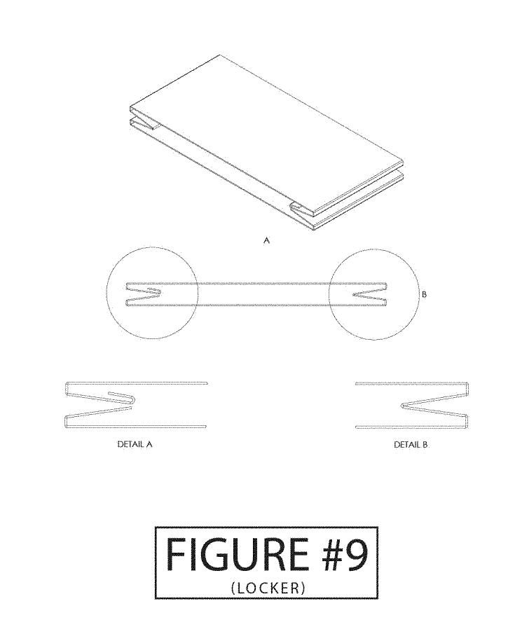

FIG. 9 is a series of views of the sliding locker.

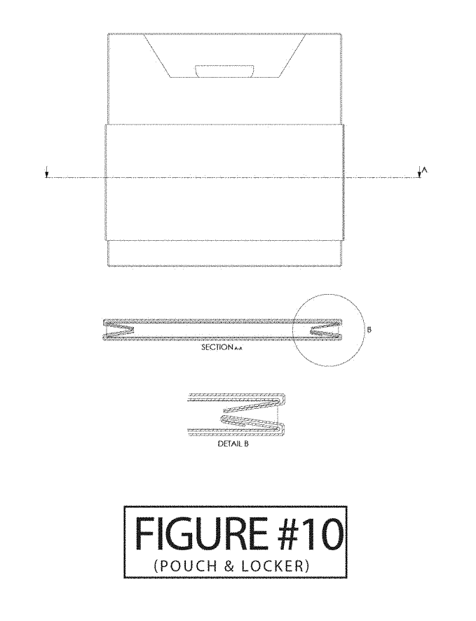

FIG. 10 is a series of views of the sliding locker and the pouch.

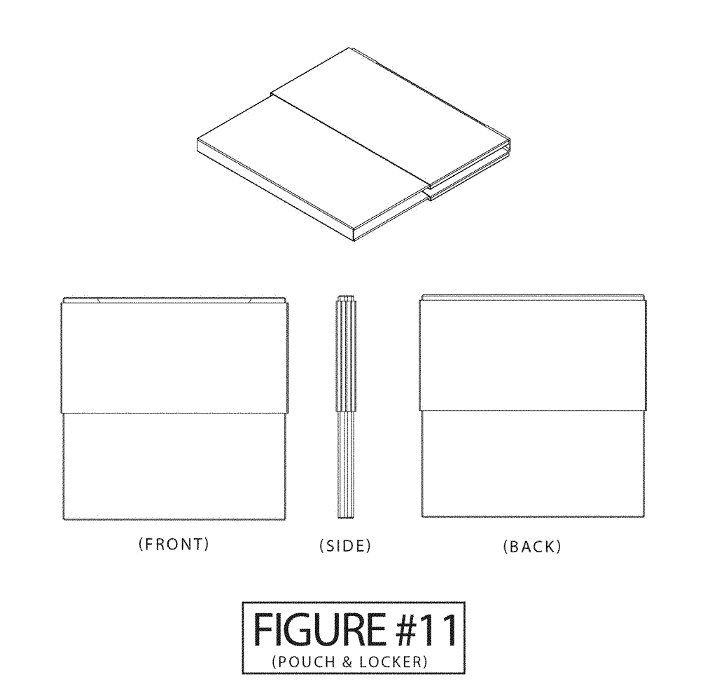

FIG. 11 is another series of views of the sliding locker and the pouch.

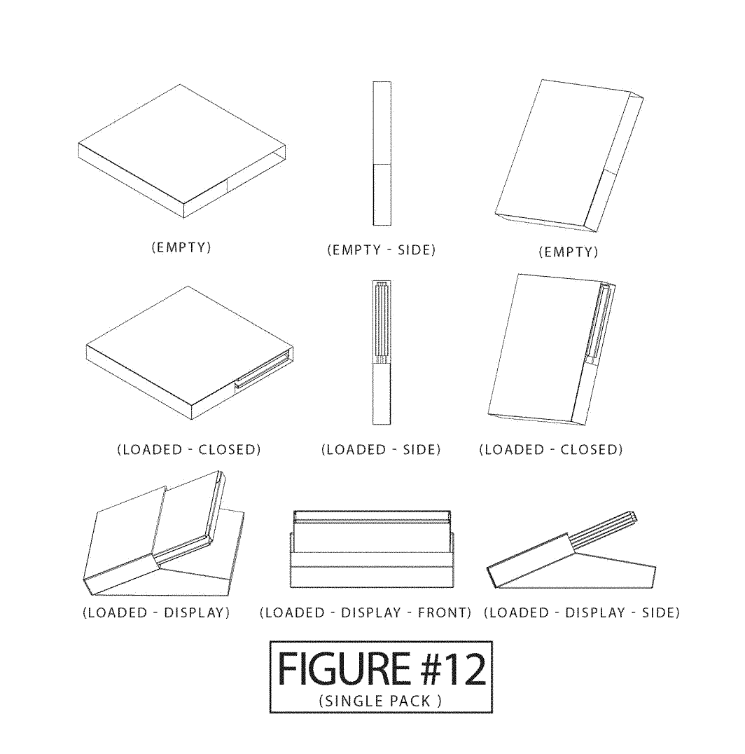

FIG. 12 is a series of views of the single pack version of the display packaging.

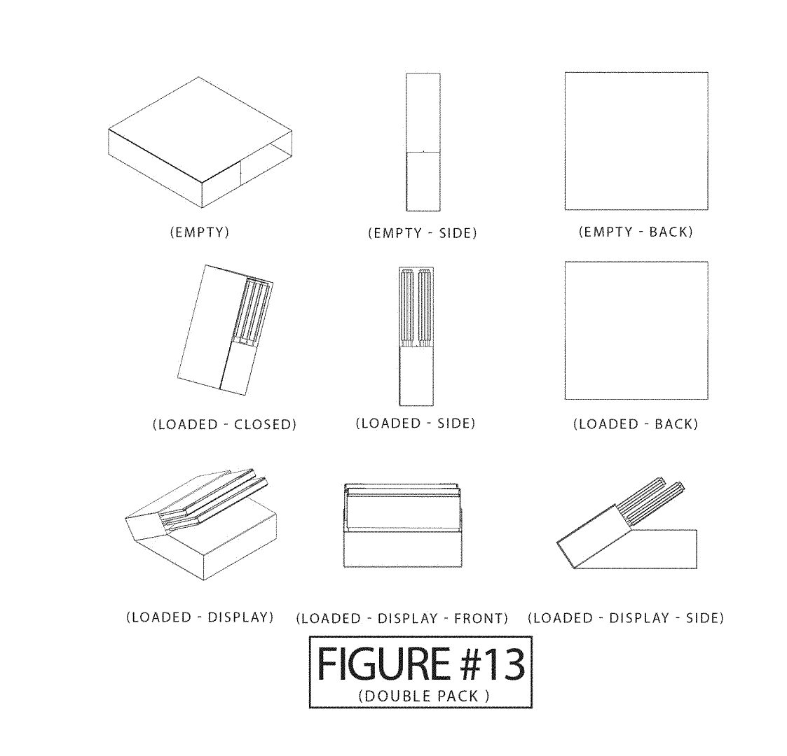

FIG. 13 is a series of views of the double pack version of the display packaging.

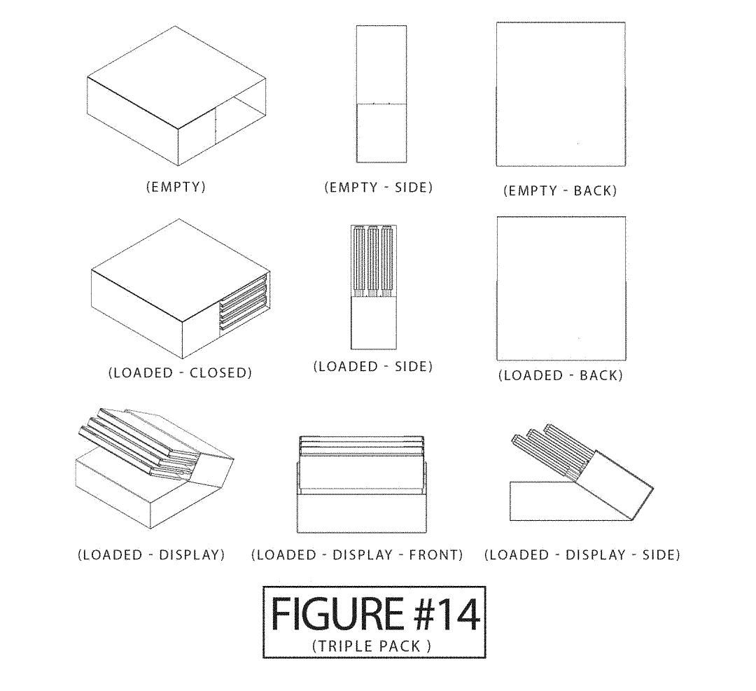

FIG. 14 is a series of views of the triple pack version of the display packaging.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention. While the a particularly preferred mode of the invention is described as a single pouch with a sliding locker, multiple iterations are contemplated—such as box-shaped 2×2 embodiments—and are included in this application.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device for retaining valuable substances, comprising: a pouch, a sliding locker, and an insert.

2. The device of claim 1, where the pouch comprises an access flap, two access flap bends, and access flap fold, a pouch top, a pouch bottom, a pouch back, a pouch front, a pouch insert opening, a locker hook tab, a locker access flap tab, a locker guide tab, and a locker access flap tab.

3. The device of claim 2, additionally comprising an access hole.

4. The device of claim 3, where, the pouch is folded along the pouch bottom and the pouch top, and then again at a plurality of access flaps, and also folded along a plurality of sides such that the pouch front and the pouch back form a cavity, called an insert opening, into which the sliding locker and insert can be inserted

5. The device of claim 4, where, after insertion of the pouch locker, the pouch is secured through the access flap, which is folded down and inserted into the access opening.

6. The device of claim 4, where the number of access flaps is three.

7. The device of claim 1, where the sliding locker comprises a plurality of locker guides, a locker front, a locker back, a locker guide fold, a locker hook, and a plurality of locker pouch folds.

8. The device of claim 7, where the locker front and the locker back have a cavity between them, where the cavity is created by the locker guide fold, the locker hook, and the plurality of locker pouch folds, and where the locker hook allows the sliding locker to be secured around the insert.

9. The device of claim 1, where the insert comprises a sheet of material that has been folded into nine roughly square sections through two folds on the horizontal axis and two folds on the vertical axis, where an insert middle is created, where the existing eight roughly square sections are then folded on top of one another to wrap the insert around the substance to be protected.

10. The device of claim 1, additionally comprising a package.

11. The device of claim 10, where the package comprises a front, a back, a top, a bottom, two sides, and where the back, the top and the two sides form a cavity between the front and the back.

12. The device of claim 10, where the cavity of the package is of sufficient size to accommodate the sliding locker device.

13. A method of making a device for retaining valuable substances, comprising: a pouch, a sliding locker, and an insert.

14. The method of claim 13, where the pouch comprises an access flap, two access flap bends, and access flap fold, a pouch top, a pouch bottom, a pouch back, a pouch front, a pouch insert opening, a locker hook tab, a locker access flap tab, a locker guide tab, and a locker access flap tab, and additionally comprising an access hole.

15. The method of claim 14, where, the pouch is folded along the pouch bottom and the pouch top, and then again at a plurality of access flaps, and also folded along a plurality of sides such that the pouch front and the pouch back form a cavity, called an insert opening, into which the sliding locker and insert can be inserted, and, where, after insertion of the pouch locker, the pouch is secured through the access flap, which is folded down and inserted into the access opening, and, where the number of access flaps is three.

16. The method of claim 15, where the sliding locker comprises a plurality of locker guides, a locker front, a locker back, a locker guide fold, a locker hook, and a plurality of locker pouch folds, where the locker front and the locker back have a cavity between them, where the cavity is created by the locker guide fold, the locker hook, and the plurality of locker pouch folds, and where the locker hook allows the sliding locker to be secured around the insert.

17. The method of claim 16, where the insert comprises a sheet of material that has been folded into nine roughly square sections through two folds on the horizontal axis and two folds on the vertical axis, where an insert middle is created, where the existing eight roughly square sections are then folded on top of one another to wrap the insert around the substance to be protected.

18. The method of claim 13, additionally comprising a package, where the package comprises a front, a back, a top, a bottom, two sides, and where the back, the top and the two sides form a cavity between the front and the back, and where, the cavity is of sufficient size to accommodate the sliding locker.

19. A method of protecting a valuable substance, comprising the steps of: first, obtaining a device, where the device, second, putting the valuable substance inside the pouch.

20. The method of claim 19, where the pouch comprises an access flap, two access flap bends, and access flap fold, a pouch top, a pouch bottom, a pouch back, a pouch front, a pouch insert opening, a locker hook tab, a locker access flap tab, a locker guide tab, and a locker access flap tab, and additionally comprises an access hole, where the pouch is folded along the pouch bottom and the pouch top, and then again at a plurality of access flaps, and also folded along a plurality of sides such that the pouch front and the pouch back form a cavity, called an insert opening, into which the sliding locker and insert can be inserted, where, after insertion of the pouch locker, the pouch is secured through the access flap, which is folded down and inserted into the access opening, where the number of access flaps is three, where the sliding locker comprises a plurality of locker guides, a locker front, a locker back, a locker guide fold, a locker hook, and a plurality of locker pouch folds, where the locker front and the locker back have a cavity between them, where the cavity is created by the locker guide fold, the locker hook, and the plurality of locker pouch folds, and where the locker hook allows the sliding locker to be secured around the insert, where the insert comprises a sheet of material that has been folded into nine roughly square sections through two folds on the horizontal axis and two folds on the vertical axis, where an insert middle is created, where the existing eight roughly square sections are then folded on top of one another to wrap the insert around the substance to be protected, additionally comprising a package, where the package comprises a front, a back, a top, a bottom, two sides, and where the back, the top and the two sides form a cavity between the front and the back, and where the cavity is of sufficient size to accommodate the sliding locker.
